(19) United States
(12) Patent Application Publication
(10) Pub. No.: US 2007/0216293 A1
(43) Pub. Date: Sep. 20, 2007

(54) LIGHT-EMITTING MATERIAL, LIGHT-EMITTING DEVICE, AND ELECTRONIC APPLIANCE

(75) Inventors: Kohei YOKOYAMA, Kanagawa (JP); Yoshiaki YAMAMOTO, Atsugi (JP); Junichiro SAKATA, Atsugi (JP); Takahiro KAWAKAMI, Kanagawa (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/679,423

(22) Filed: Feb. 27, 2007

(30) Foreign Application Priority Data
Mar. 3, 2006 (JP) 2006-058758

(51) Int. Cl. H05B 33/14; H05B 33/00

(52) U.S. Cl. 313/506; 313/503; 313/504

(57) ABSTRACT

It is an object of the present invention to provide a light-emitting material with high light emission intensity. It is another object to provide a light-emitting element with high light emission efficiency. Moreover, it is another object to provide a light-emitting device and an electronic appliance with reduced power consumption. A light-emitting material contains at least a light-emitting substance, a base material, and an additive which is an element belonging to group 14 of the periodic table or a compound containing two or more kinds of elements belonging to group 14, or a compound containing at least two or more kinds of elements each belonging to a different group chosen from group 13, group 14, and group 15. Due to the light-emitting material, a light-emitting element and an electronic appliance which has high light emission efficiency and can be driven at a low voltage can be obtained.

### TECHNICAL FIELD

The present invention relates to a light-emitting element utilizing electroluminescence. The present invention also relates to a light-emitting device and an electronic appliance having the light-emitting element.

### BACKGROUND ART

In recent years, a display device in a television set, a mobile phone, a digital camera, or the like has been required to be flat and thin, and a display device utilizing a self-luminous light-emitting element has attracted attention as a display device for meeting this requirement. A light-emitting element utilizing electroluminescence is given as one of the self-luminous light-emitting elements. In this light-emitting element, a light-emitting material is interposed between a pair of electrodes and light emission from the light-emitting material can be obtained by applying a voltage.

Such a self-luminous light-emitting element has advantages that visibility of a pixel is high in comparison with a liquid crystal display and that a backlight is not required, thereby being considered to be suitable as a flat panel display element. In addition, such a light-emitting element can be manufactured to be thin and light, which is a big advantage. Moreover, the light-emitting element has a feature that response speed is extremely fast.

Furthermore, since such a self-luminous light-emitting element can be formed into a film form, plane emission can be easily obtained by formation of a large-area element. This characteristic is difficult to be obtained by a point light source typified by an incandescent lamp or an LED, or a line light source typified by a fluorescent lamp. Therefore, the light-emitting element has a high utility value as a surface light source that can be applied to lighting or the like.

A light-emitting element utilizing electroluminescence is classified by whether a light-emitting material is an organic compound or an inorganic compound. In general, the former is referred to as an organic EL element and the latter is referred to as an inorganic EL element.

The inorganic EL element is classified into a dispersion type inorganic EL element and a thin film type inorganic EL element, depending on its element structure. The former and the latter are different in that the former has a light-emitting layer in which particles of a light-emitting material are dispersed, whereas the latter has a light-emitting layer formed of a thin film of a light-emitting material. In general, a high electric filed is required in order to obtain light emission from the inorganic EL element and several hundred volts are required to be applied to the light-emitting element. For example, an inorganic EL element emitting blue light with high luminance which is required for a full color display has been recently developed, and a driving voltage of 100 to 200 V is required (for example, Non Patent Document: Japanese Journal of Applied Physics, 1999, Vol. 38, pp L1291-L1292). Therefore, the inorganic EL element has high power consumption and has been difficult to be applied to a medium or small-sized display, for example, a display of a mobile phone or the like.

### DISCLOSURE OF INVENTION

In view of the foregoing problems, it is an object of the present invention to provide a light-emitting material having higher light emission intensity than that of a conventional light-emitting material. It is another object of the present invention to provide a light-emitting element having high light emission efficiency. Moreover, it is another object of the present invention to provide a light-emitting device and an electronic appliance with reduced power consumption.

According to one feature of the present invention, a light-emitting material has a light-emitting substance, a base material, and an additive, where the light-emitting substance is an element which becomes an emission center and the additive is an element belonging to group 14 of the periodic table.

According to another feature of the present invention, a light-emitting material has a light-emitting substance, a base material, and an additive, where the light-emitting substance is an element which becomes an emission center and the additive is a compound containing two or more kinds of elements belonging to group 14 of the periodic table.

According to another feature of the present invention, a light-emitting material has a light-emitting substance, a base material, and an additive, where the light-emitting substance is an element which becomes an emission center and the additive is a compound containing at least two or more kinds of elements each belonging to a different group chosen from group 13, group 14, and group 15 of the periodic table.

According to another feature of the present invention, a light-emitting material has a light-emitting substance, a base material, and an additive, where the light-emitting substance is an element which becomes an emission center and the additive is a compound containing one or more kinds of elements each belonging to group 13, group 14, or group 15 of the periodic table.

According to another feature of the present invention, the additive contains two or more kinds of elements belonging to the same group.

According to another feature of the present invention, a light-emitting element has a first electrode, a second electrode, and a light-emitting layer containing a light-emitting substance, a base material, and an additive, which is interposed between the first electrode and the second electrode, where the additive is an element belonging to group 14 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing two or more kinds of elements belonging to group 14 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing at least two or more kinds of elements each belonging to a different group chosen from group 13, group 14, and group 15 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing one or more kinds of elements each belonging to group 13 or group 14 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing one or more kinds of elements each belonging to group 13 or group 15 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing one or more kinds of elements each belonging to group 14 or group 15 of the periodic table.

According to another feature of the present invention, a light-emitting element has a first electrode, a second electrode, and a light-emitting layer containing a light-emitting substance, a base material, and an additive, which is interposed between the first electrode and the second electrode, where the additive is a compound containing one or more kinds of elements each belonging to group 13, group 14, or group 15 of the periodic table.

In the light-emitting element, an insulating layer may be provided between either or both the first electrode and the light-emitting layer, and the second electrode and the light-emitting layer.

According to another feature of the present invention, a light-emitting substance is an element which becomes an emission center. According to another feature of the present invention, the base material is a compound containing at least one or more kinds of elements each belonging to group 2A or group 6B of the periodic table, or a compound containing at least one or more kinds of elements each belonging to group 2B or group 6B of the periodic table. According to another feature of the present invention, the light-emitting substance is manganese, silver, copper, samarium, terbium, erbium, thulium, europium, cerium, or praseodymium.

A light-emitting device having the above-described light-emitting element is included in the category of the present invention. The light-emitting device in this specification includes an image display device, a light-emitting device, or a light source (including a lighting device) in the category. In addition, a light-emitting device includes a module in which a connector such as an FPC (Flexible Printed Circuit), a TAB (Tape Automated Bonding) tape, or a TCP (Tape Carrier Package) is attached to a panel where a light-emitting element is formed, a module where an end of the TAB tape or the TCP is provided with a printed wiring board, or a module where an IC (Integrated Circuit) is directly mounted on a light-emitting element by a COG (Chip On Glass) method.

In addition, an electronic appliance in which the light-emitting element of the present invention is used for a display portion is also included in the category of the present invention. Thus, according to another feature of the present invention, an electronic appliance of the present invention has a display portion and the display portion is provided with the above-described light-emitting element and control means for controlling light emission.

By the present invention, a light-emitting material with high light emission intensity can be obtained.

In addition, a light-emitting element which has high light emission efficiency and can be driven at a low voltage can be provided. Furthermore, by manufacturing a light-emitting device and an electronic appliance with the use of the light-emitting element, power consumption can be reduced. Moreover, a driver circuit having high resistance to voltage is not required, and thus, the light-emitting device and the electronic appliance can be manufactured at low costs.

### BRIEF DESCRIPTION OF DRAWINGS

In the accompanying drawings:

FIGS. 1A and 1B are views each explaining a light-emitting element of the present invention;

FIGS. 2A and 2B are views each explaining a light-emitting device of the present invention;

FIG. 3 is a view explaining a light-emitting device of the present invention;

FIGS. 4A to 4D are views each explaining an electronic appliance of the present invention;

FIG. 5 is a view explaining an electronic appliance of the present invention;

FIG. 6 is a view explaining an electronic appliance of the present invention;

FIG. 7 is a view explaining a lighting device of the present invention;

FIG. 8 is a view explaining a lighting device of the present invention;

FIG. 9 is a view explaining a light-emitting element manufactured in Embodiment 2; and

FIG. 10 is a graph showing voltage-luminance characteristics of light-emitting elements manufactured in Embodiment 2.

### BEST MODE FOR CARRYING OUT THE INVENTION

Hereinafter, embodiment modes of the present invention will be explained with reference to the drawings. However, the present invention is not limited to the explanation below, and it is easily understood by those skilled in the art that the modes and the details of the present invention can be modified in various ways without departing from the purpose and the scope of the present invention. Therefore, the present invention is not interpreted as being limited to the description of the embodiment modes to be given below.

### EMBODIMENT MODE 1

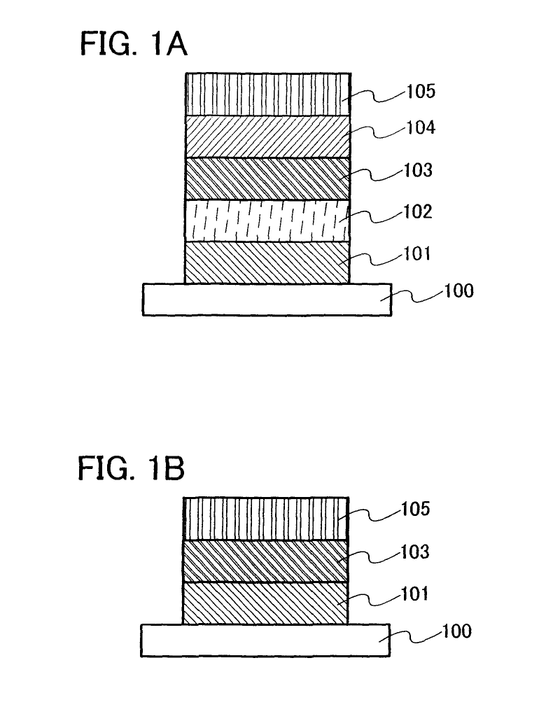

In this embodiment mode, a light-emitting element of the present invention will be explained with reference to FIGS. 1A and 1B.

As shown in FIG. 1A, the light-emitting element shown in this embodiment mode has an element structure in which, over a substrate 100, a first electrode 101 and a second electrode 105 are provided, a first insulating layer 102 and a second insulating layer 104 are provided between the first electrode 101 and the second electrode 105, and a light-emitting layer 103 is provided between the first insulating layer 102 and the second insulating layer 104. It is to be noted that the first insulating layer 102 and the second insulating layer 104 are not necessarily required, and one of them can be omitted or both can be omitted as shown in FIG. 1B.

The substrate 100 is used as a supporting body of the light-emitting element. For example, glass, quartz, plastic, or the like can be used for forming the substrate 100. Further, other materials can also be used as long as they serves as a supporting body in manufacturing steps of the light-emitting element.

A metal, an alloy, a conductive compound, a mixture of these, or the like can be used for forming the first electrode 101 and the second electrode 105. Specifically, for example, indium oxide-tin oxide (also referred to as indium tin oxide (ITO)); indium oxide-tin oxide containing silicon or silicon oxide (ITSO: indium tin silicon oxide); indium oxide-zinc oxide (also referred to as indium zinc oxide (IZO)); indium oxide-tin oxide containing tungsten oxide and zinc oxide (IWZO); or the like is given. For example, indium zinc oxide (IZO) can be formed by sputtering with the use of a target in which 1 to 20 wt % of zinc oxide is added to indium oxide. Also, indium oxide-tin oxide containing tungsten oxide and zinc oxide (IWZO) can be formed by sputtering with the use of a target in which 0.5 to 5 wt % of tungsten oxide and 0.1 to 1 wt % of zinc oxide are added to indium oxide. In addition, aluminum (Al), silver (Ag), gold (Au), platinum (Pt), nickel (Ni), tungsten (W), chromium (Cr), molybdenum (Mo), iron (Fe), cobalt (Co), copper (Cu), palladium (Pd), a nitride of a metal material (for example, titanium nitride: TiN), or the like can be used.

However, since light emission is extracted to outside through the first electrode 101 or the second electrode 105, at least one of the first electrode 101 and the second electrode 105 is required to be formed of a light-transmitting material. Even if a material having low transmission of visible light is used, the material can be used as a light-transmitting electrode by being formed with a thickness of greater than or equal to 1 mm and less than or equal to 50 nm, preferably, greater than or equal to 5 nm and less than or equal to 20 nm.

The light-emitting element of the present invention can be operated by either a DC drive or an AC drive. When the light-emitting element is operated by a DC drive, it is preferable to appropriately select materials so that a work function of an electrode serving as an anode is higher than that of an electrode serving as a cathode. However, the materials are not limited thereto.

The first insulating layer 102 and the second insulating layer 104 can be formed with the use of an insulating inorganic substance or an insulating organic substance. Further, when an inorganic substance is used, it is preferable to use an oxide or nitride with high dielectric constant. For example, strontium titanate, barium titanate, lithium titanate, lead titanate, calcium titanate, potassium niobate, silicon nitride, silicon oxide, aluminum nitride, yttrium oxide, tantalum oxide, or the like is given. As an organic substance, an acetal resin, an epoxy resin, methyl methacrylate, polyester, polystyrene, polycarbonate, a phenol resin, polystyrol, polytetrafluoroethylene, a bisphenol based epoxy resin, polyethylene, polyvinylidene fluoride, cyanoethyl cellulose, or the like can be used. It is to be noted that the material is not limited to the material with high dielectric constant as long as the material has an insulating property.

The light-emitting layer 103 is formed of a light-emitting material having at least a light-emitting substance, a base material, and an additive. As an additive, a compound containing at least two or more kinds of elements each belonging to a different group chosen from group 13, group 14, and group 15 of the periodic table can be used, in addition to an element belonging to group 14. Further, two or more kinds of elements belonging to the same group may be contained. An example is shown below.

As an element belonging to group 14, carbon, silicon, germanium, tin, and lead are given, and one of them can be used as the additive. In addition, two or more kinds of elements belonging to group 14 may be contained, and silicon carbide or the like is given as an example.

As a typical compound containing one or more kinds of elements each belonging to group 13 or group 14, which is used as the additive, aluminum carbide, silicon boride, or the like is given. In addition, two or more kinds of elements belonging to the same group may be contained. As a typical compound containing one or more kinds of elements each belonging to group 13 or group 15, aluminum nitride, aluminum phosphide, aluminum arsenide, gallium nitride, gallium phosphide, gallium arsenide, indium phosphide, indium arsenide, indium antimonide, or the like is given. Also, like gallium indium arsenide, two or more kinds of elements belonging to the same group may be contained. As a typical compound containing one or more kinds of elements each belonging to group 14 or group 15, silicon nitride or the like is given. In addition, two or more kinds of elements belonging to the same group may be contained. Further, a compound containing one or more kinds of elements each belonging to group 13, group 14, or group 15 can be used. It is to be noted that these additives are preferably mixed at greater than or equal to 0.1 mmol % and less than or equal to 10 mmol % with respect to the base material.

The base material or the light-emitting substance is not particularly limited. For example, as the base material, a compound containing at least one or more kinds of elements each belonging to group 2A or group 6B is given. For example, magnesium oxide, calcium oxide, strontium oxide, barium oxide, magnesium sulfide, calcium sulfide, strontium sulfide, barium sulfide, magnesium selenide, calcium selenide, strontium selenide, barium selenide, magnesium telluride, calcium telluride, strontium telluride, barium telluride, or the like is given. Also, like strontium barium sulfide, a compound containing one or more kinds of elements each belonging to group 2A or group 6B may be used. In addition, a compound containing at least one or more kinds of elements each belonging to group 2B or group 6B may be used. For example, zinc oxide, cadmium oxide, mercury oxide, zinc sulfide, cadmium sulfide, mercury sulfide, zinc selenide, cadmium selenide, mercury selenide, zinc telluride, cadmium telluride, mercury telluride, or the like is given. Also, like zinc cadmium sulfide, a compound containing one or more kinds of elements each belonging to group 2B or group 6B may be used.

A substance serving as an emission center may be used as the light-emitting substance. For example, a metal element such as manganese, silver, copper, samarium, terbium, erbium, thulium, europium, cerium, or praseodymium can be used. Furthermore, in addition to these metal elements, a halogen element such as fluorine, chlorine, bromine, or iodine may be added to the light-emitting layer 103 for charge compensation.

Furthermore, the light-emitting layer 103 may have copper fluoride (CuF₂), copper chloride (CuCl), copper iodide (CuI), copper bromide (CuBr), copper nitride (Cu₃N), copper phosphide (Cu₃P), silver fluoride (AgF), silver chloride (AgCl), silver iodide (AgI), silver bromide (AgBr), gold chloride (AuCl₃), gold bromide (AuBr₃) or the like, in addition to a light-emitting substance, a base material, and an additive.

The light-emitting material of the present invention as described above which forms the light-emitting layer 103 has at least a light-emitting substance, a base material, and an additive, whereby light emission intensity can be increased.

The first electrode 101, the second electrode 105, the light-emitting layer 103, the first insulating layer 102, and the second insulating layer 104 can be formed by methods appropriately selected from the following. Specifically, a vacuum evaporation method such as a resistance heating evaporation method or an electron beam evaporation (EB evaporation) method; a physical vapor deposition method (PVD) such as a sputtering method; a chemical vapor deposition method (CVD) such as an organic metal CVD method or a hydride transfer low-pressure CVD method; an atomic layer epitaxy method (ALE); or the like can be used. In addition, an ink-jet method, a spin coating method, a printing method, or the like can be used. Each electrode and each layer may be formed using different methods.

For example, when the light-emitting layer 103 is formed, a material obtained by a method in which a light-emitting substance, a base material, and an additive are weighed, mixed in a mortar, and subjected to a reaction by heating in an electric furnace may be used as an evaporation material. A baking temperature is preferably greater than or equal to 700° C. and less than or equal to 1500° C. This is because the reaction does not proceed when the temperature is too low, and the material is decomposed when the temperature is too high. Although the baking may be performed in a powder state, the baking is preferably performed in a pellet state. The formation method is not limited thereto and the light-emitting layer 103 can be formed by co-evaporating the above materials. In addition, the formation method is not limited to evaporation and the light-emitting layer 103 can be formed by methods appropriately selected from the above methods. It is further preferable that laser beam irradiation or heating of the substrate 100 be performed when the light-emitting layer 103 is formed or right after the light-emitting layer 103 is formed.

The insulating layer and the light-emitting layer 103 which are interposed between the first electrode 101 and the second electrode 105 may be mixed in the light-emitting element of the present invention.

As described above, a light-emitting element which has high light emission efficiency and can be driven at a low voltage can be obtained.

It is to be noted that this embodiment mode can be appropriately combined with other embodiment modes.

### EMBODIMENT MODE 2

In this embodiment mode, a light-emitting device having a light-emitting element of the present invention will be explained.

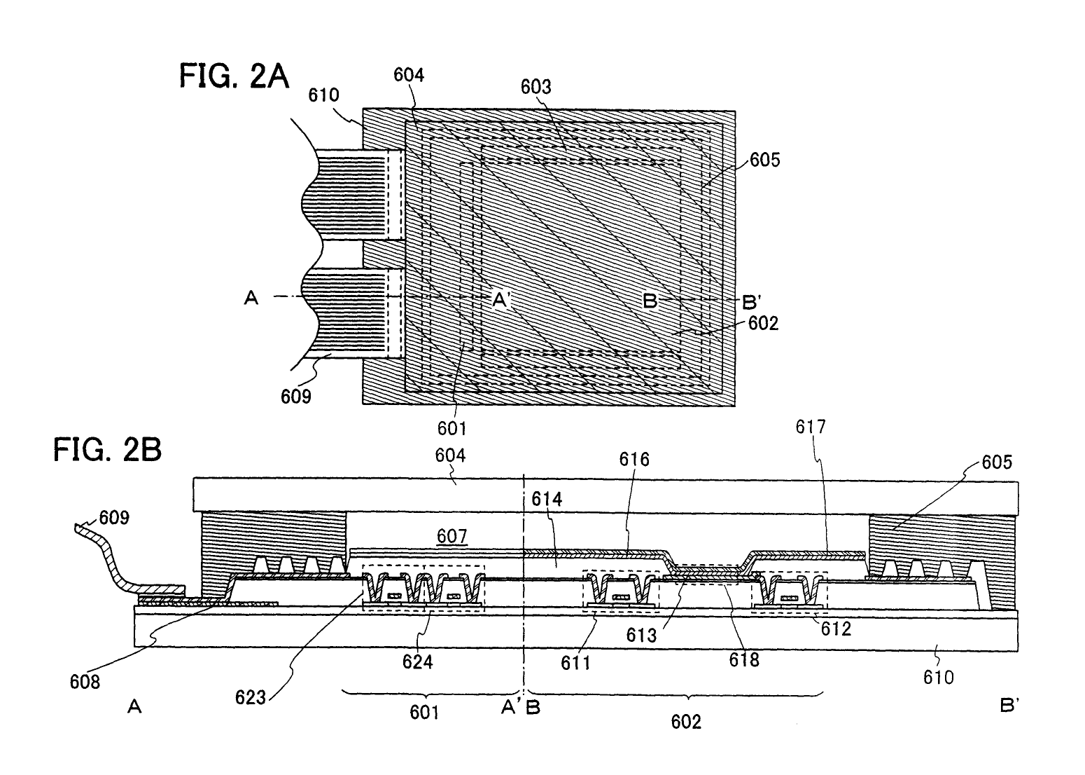

In this embodiment mode, an active light-emitting device in which driving of a light-emitting element is controlled by a transistor will be explained. In this embodiment mode, a light-emitting device having the light-emitting element of the present invention for a pixel portion will be explained with reference to FIGS. 2A and 2B. It is to be noted that FIG. 2A is a top view showing the light-emitting device and FIG. 2B is a cross-sectional view taken along a line A-A′ and B-B′ of FIG. 2A. Reference numeral 601 denotes a driver circuit portion (a source side driver circuit), 602 denotes a pixel portion, and 603 denotes a driver circuit portion (a gate side driver circuit), each of which is indicated by a dotted line. In addition, reference numeral 604 denotes a sealing substrate and 605 denotes a sealant, and a portion surrounded by these and a substrate 610 is a space 607.

A leading wiring 608 is a wiring for transmitting a signal input to the source side driver circuit 601 and the gate side driver circuit 603. The leading wiring 608 receives a video signal, a clock signal, a start signal, a reset signal, or the like from an FPC (Flexible Printed Circuit) 609 which becomes an external input terminal. It is to be noted that, although only the FPC is shown here, a printed wiring board (PWB) may be attached to the FPC. The light-emitting device in this specification includes not only the light-emitting device body itself but also a state in which an FPC or a PWB is attached thereto.

Next, a cross-sectional structure will be explained with reference to FIG. 2B. Although the driver circuit portion and the pixel portion are formed over the substrate 610, the source side driver circuit 601 that is a driver circuit portion and one pixel in the pixel portion 602 are shown here.

It is to be noted that the source side driver circuit 601 is formed by a CMOS circuit in which an n-channel TFT 623 and a p-channel TFT 624 are combined. In addition, the driver circuit including a TFT may be formed using a known CMOS circuit, PMOS circuit, or NMOS circuit. Although this embodiment mode shows a driver integrated type in which a driver circuit is formed over a substrate, this is not always necessary and all or part of a peripheral driver circuit can also be provided outside a substrate, not over the substrate. In addition, the driver circuit may be formed over an IC chip or the like, and the IC chip may be mounted by COG (Chip On Glass) or the like.

The pixel portion 602 is formed by a plurality of pixels, each of which includes a switching TFT 611, a current controlling TFT 612, and a first electrode 613 electrically connected to a drain of the current controlling TFT 612. Further, an insulator 614 is formed covering edge portions of the first electrode 613. Here, the insulator 614 is formed with the use of a positive photosensitive acrylic resin film.

In order to obtain favorable deposition coverage of a layer 616 containing a light-emitting material to be formed later, the insulator 614 is formed to have a curved surface with curvature at an upper edge portion or a lower edge portion thereof. For example, when positive photosensitive acrylic is used as a material for the insulator 614, it is preferable that only the top edge portion of the insulator 614 have curvature having a curvature radius (0.2 to 3 μm). In addition, as the insulator 614, either a negative type which becomes insoluble in an etchant by light irradiation or a positive type which becomes soluble in an etchant by light irradiation can be used. Moreover, the material for the insulator 614 is not limited to an organic material and an inorganic material. For example, silicon oxide, silicon oxynitride, or the like can be used.

The layer 616 containing the light-emitting material and a second electrode 617 are formed over the first electrode 613. The light-emitting material of the present invention included in the layer 616 has at least a light-emitting substance, a base material, and an additive. An element belonging to group 14 of the periodic table or a compound containing two or more kinds of elements belonging to group 14, or a compound containing at least two or more kinds of elements each belonging to a different group chosen from group 13, group 14, and group 15 can be used. Further, the first electrode 613, the layer 616 containing the light-emitting material, and the second electrode 617 can be formed using the materials appropriately selected from those described in Embodiment Mode 1. It is to be noted that at least one of the first electrode 613 and the second electrode 617 has a light-transmitting property, and light emission can be extracted to outside from the electrode side.

Various methods can be used for forming the first electrode 613, the layer 616 containing the light-emitting material, and the second electrode 617. Specifically, a vacuum evaporation method such as a resistance heating evaporation method or an electron beam evaporation (EB evaporation) method; a physical vapor deposition method (PVD) such as a sputtering method; a chemical vapor deposition method such as an organic metal CVD method or a hydride transfer low-pressure CVD method; an atomic layer epitaxy method (ALE); or the like can be used. In addition, an ink-jet method, a spin coating method, or the like can be used. Each electrode and each layer may be formed using different methods.

The sealing substrate 604 and the substrate 610 are attached to each other with the use of the sealant 605, whereby a structure is obtained in which a light-emitting element 618 of the present invention including the first electrode 613, the layer 616 containing the light-emitting material, and the second electrode is provided in the space 607 surrounded by the substrate 610, the sealing substrate 604, and the sealant 605. Further, the space 607 is filled with a filler, but there is also a case where the space 607 is filled with the sealant 605 or filled with an inert gas (such as nitrogen or argon).

It is preferable to use an epoxy based resin for the sealant 605. It is desirable that these materials transmit as little moisture or oxygen as possible. As a material used for the sealing substrate 604, in addition to a glass substrate or a quartz substrate, a plastic substrate formed from FRP (Fiberglass-Reinforced Plastics), PVF (polyvinylfluoride), myler, polyester, acrylic, or the like can be used.

As described above, the light-emitting device having the light-emitting element of the present invention can be obtained. Further, the obtained light-emitting device may be driven by a DC drive or an AC drive.

The light-emitting device of this embodiment mode has the light-emitting element of the present invention which has high light emission efficiency and can be driven at a low voltage. Therefore, power consumption can be reduced. Furthermore, since a driver circuit having high resistance to voltage is not required, manufacturing costs can be reduced. Moreover, the weight of the light-emitting device can be reduced and the size of the driver circuit portion can be reduced.

It is to be noted that this embodiment mode can be appropriately combined with other embodiment modes.

### EMBODIMENT MODE 3

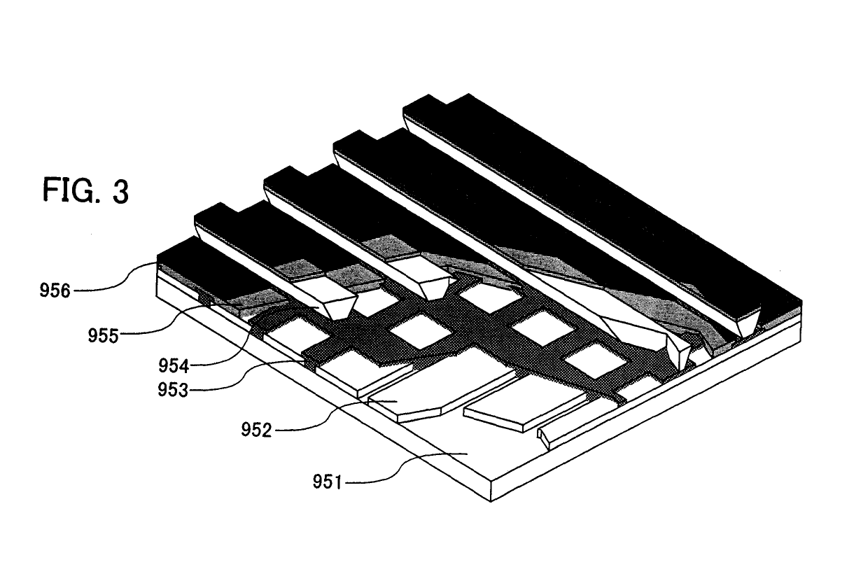

In this embodiment mode, a light-emitting device having a light-emitting element of the present invention will be explained with reference to FIG. 3.

The light-emitting device shown in this embodiment is a passive light-emitting device in which a light-emitting element is driven without particularly providing an element for driving, such as a transistor, in a pixel portion. A perspective view of the passive light-emitting device to which the present invention is applied is shown in FIG. 3. Further, the light-emitting device may be driven by a DC drive or an AC drive.

In FIG. 3, over a substrate 951, a layer 955 containing a light-emitting material is provided between a first electrode 952 and a second electrode 956. Further, the light-emitting material of the present invention included in the layer 955 has at least a light-emitting substance, a base material, and an additive. As the additive, an element belonging to group 14 of the periodic table or a compound containing two or more kinds of elements belonging to group 14, or a compound containing at least two or more kinds of elements each belonging to a different group chosen from group 13, group 14, or group 15 can be used.

An edge portion of the first electrode 952 is covered with an insulating layer 953. A partition layer 954 is provided over the insulating layer 953. Sidewalls of the partition wall 954 have such inclination in that a distance between one of the sidewalls and the other becomes narrower toward a substrate surface. In other words, a cross-sectional surface of a short side direction of the partition wall 954 is trapezoid, in which a base (a side which is in contact with the insulating layer 953) is shorter than a top (a side which is not in contact with the insulating layer 953). In this manner, the partition wall 954 is provided, whereby defects of the light-emitting element due to static electricity or the like can be prevented.

As described above, the light-emitting device of this embodiment mode has the light-emitting element of the present invention which has high light emission efficiency and can be driven at a low voltage. Therefore, power consumption can be reduced. Furthermore, since a driver circuit having high resistance to voltage is not required, manufacturing costs can be reduced. Moreover, the weight of the light-emitting device can be reduced and the size of the driver circuit portion can be reduced.

It is to be noted that this embodiment mode can be appropriately combined with other embodiment modes.

### EMBODIMENT MODE 4

In this embodiment mode, an electronic appliance to which the present invention is applied will be explained. It is to be noted that, when an electronic appliance includes a light-emitting element which has high light emission efficiency and can be driven at a low voltage, an electronic appliance with low power consumption can be manufactured at low cost.

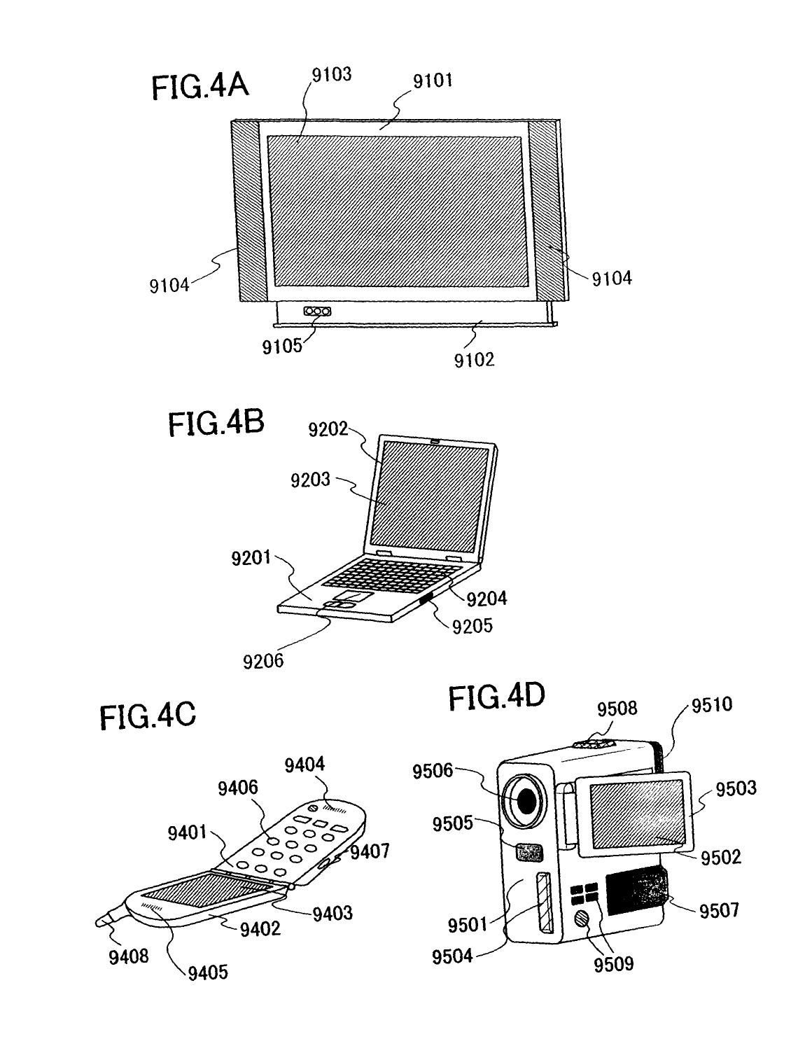

As an electronic appliance to which the present invention is applied, a camera such as a video camera or a digital camera, a goggle type display, a navigation system, a sound reproducing device (such as a car audio or an audio component), a computer, a game machine, a mobile information terminal (such as a mobile computer, a mobile phone, a mobile game machine, or an electronic book), an image reproducing device equipped with a recording medium (specifically, a device for reproducing a recording medium such as a digital versatile disc (DVD), which is equipped with a display device for displaying the reproduced image), or the like is given. Specific examples of the electronic appliances are shown in FIGS. 4A to 4D.

FIG. 4A shows a television device of the present invention, which includes a housing 9101, a supporting base 9102, a display portion 9103, a speaker portion 9104, a video input terminal 9105, and the like. Light-emitting elements similar to the light-emitting element explained in the above embodiment mode are arranged in matrix to form the display portion 9103. A light-emitting material of the present invention included in the light-emitting element has at least a light-emitting substance, a base material, and an additive. As the additive, an element belonging to group 14 of the periodic table or a compound containing two or more kinds of elements belonging to group 14, or a compound containing at least two or more kinds of elements each belonging to a different group chosen from group 13, group 14, and group 15 can be used. Such a light-emitting element of the present invention has high light emission efficiency and can be driven at a low voltage. In addition, a short circuit due to an impact from an external source or the like can be prevented. Therefore, the display portion 9103 has a similar feature, and thus, in this television device, there is no deterioration of image quality and low power consumption is achieved. By such a feature, a deterioration compensation function or a power supply circuit can be drastically lowered or reduced; thus, reduction in the size and weight of the housing 9101 or the supporting base 9102 and reduction in the cost can be achieved. In the television device of the present invention, low power consumption, high image quality, and reduction in the size and weight are achieved, and thus, a product that is suitable for the living environment can be provided.

FIG. 4B shows a computer of the present invention, which includes a main body 9201, a housing 9202, a display portion 9203, a keyboard 9204, an external connection port 9205, a pointing mouse 9206, and the like. In this computer, light-emitting elements similar to the light-emitting element explained in the above embodiment mode are arranged in matrix to form the display portion 9203. A light-emitting material of the present invention included in the light-emitting element has at least a light-emitting substance, a base material, and an additive. As the additive, an element belonging to group 14 of the periodic table or a compound containing two or more kinds of elements belonging to group 14, or a compound containing at least two or more kinds of elements each belonging to a different group chosen from group 13, group 14, and group 15 can be used. Such a light-emitting element of the present invention has high light emission efficiency and can be driven at a low voltage. In addition, a short circuit due to an impact from an external source or the like can be prevented. The display portion 9203 including the light-emitting element has a similar feature; therefore, in this computer, there is no deterioration of image quality and low power consumption is achieved. By such a feature, in the computer, a deterioration compensation function or a power supply circuit can be drastically lowered or reduced; thus, reduction in the size and weight of the main body 9201 or the housing 9202 or reduction in the cost can be achieved. In the computer of the present invention, low power consumption, high image quality, and reduction in the size and weight are achieved, and thus, a product that is suitable for the living environment can be provided. Moreover, the computer can be carried around, and it is possible to provide a computer including a display portion that is able to withstand an impact from an external source when being carried.

FIG. 4C shows a mobile phone of the present invention, which includes a main body 9401, a housing 9402, a display portion 9403, a sound input portion 9404, a sound output portion 9405, an operation key 9406, an external connection port 9407, an antenna 9408, and the like. In this mobile phone, light-emitting elements similar to the light-emitting element explained in the above embodiment mode are arranged in matrix to form the display portion 9403. A light-emitting material of the present invention included in the light-emitting element has at least a light-emitting substance, a base material, and an additive. As the additive, an element belonging to group 14 of the periodic table or a compound containing two or more kinds of elements belonging to group 14, or a compound containing at least two or more kinds of elements each belonging to a different group chosen from group 13, group 14, and group 15 can be used. Such a light-emitting element of the present invention has high light emission efficiency and can be driven at a low voltage. In addition, a short circuit due to an impact from an external source or the like can be prevented. The display portion 9403 including the light-emitting element has a similar feature; therefore, in this mobile phone, there is no deterioration of image quality and low power consumption is achieved. By such a feature, in the mobile phone, a deterioration compensation function or a power supply circuit can be drastically lowered or reduced; thus, reduction in the size and weight of the main body 9401 or the housing 9402 or reduction in the cost can be achieved. In the mobile phone of the present invention, low power consumption, high image quality, and reduction in the size and weight are achieved, and thus, a product that is suitable for being carried can be provided. Moreover, a product including a display portion that is able to withstand an impact when being carried can be provided. Further, the operation key 9406 may be formed using the light-emitting element of the present invention.

FIG. 4D shows a camera of the present invention, which includes a main body 9501, a display portion 9502, a housing 9503, an external connection port 9504, a remote control receiving portion 9505, an image receiving portion 9506, a battery 9507, a sound input portion 9508, an operation key 9509, an eyepiece portion 9510, and the like. In this camera, light-emitting elements similar to the light-emitting element explained in the above embodiment mode are arranged in matrix to form the display portion 9502. A light-emitting material of the present invention included in the light-emitting element has at least a light-emitting substance, a base material, and an additive. As the additive, an element belonging to group 14 of the periodic table or a compound containing two or more kinds of elements belonging to group 14, or a compound containing at least two or more kinds of elements each belonging to a different group of group 13, group 14, and group 15 can be used. Such a light-emitting element of the present invention has high light emission efficiency and can be driven at a low voltage. In addition, a short circuit due to an impact from an external source or the like can be prevented. The display portion 9502 including the light-emitting element has a similar feature; thus, in this camera, there is no deterioration of image quality and low power consumption is achieved. By such a feature, in the camera, a deterioration compensation function or a power supply circuit can be drastically lowered or reduced; therefore, reduction in the size and weight of the main body 9501 or the housing 9503 or reduction in the cost can be achieved. In the camera of the present invention, low power consumption, high image quality, and reduction in the size and weight are achieved, and thus, a product that is suitable for being carried can be provided. Moreover, a product including a display portion that is able to withstand an impact when being carried can be provided. Further, the operation key 9509 may be formed using the light-emitting element of the present invention.

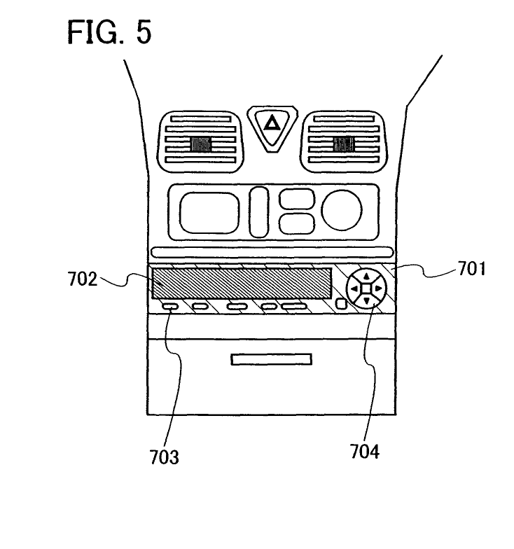

FIG. 5 shows an audio reproducing device. Specifically, it is a car audio system, which includes a main body 701, a display portion 702, and operation switches 703 and 704. The display portion 702 can be realized using the light-emitting device (active type) of Embodiment Mode 2 or the light-emitting device (passive type) of Embodiment Mode 3. In addition, this display portion 702 may also be formed using a light-emitting device of a segment type. In either case, the use of a light-emitting material of the present invention makes it possible to form a bright display portion while achieving low power consumption, with the use of vehicular power (12 to 42V). Although an in-car audio system is shown in this embodiment mode, the present invention may be used for a portable audio device or an audio device for household use.

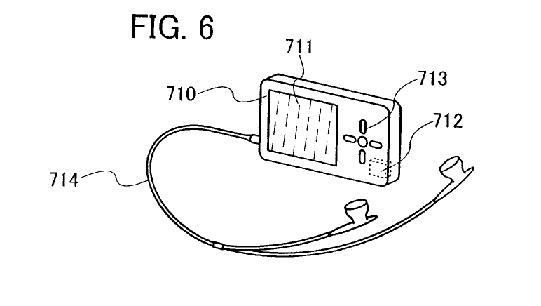

FIG. 6 shows a digital player as an example thereof. The digital player shown in FIG. 6 includes a main body 710, a display portion 711, a memory portion 712, an operation portion 713, earphones 714, and the like. Further, headphones or wireless earphones can be used instead of the earphones 714. The display portion 711 can be realized using the light-emitting device (active type) of Embodiment Mode 2 or the light-emitting device (passive type) of Embodiment Mode 3. In addition, this display portion 711 may also be formed using a light-emitting device of a segment type. In either case, the use of the light-emitting material of the present invention makes it possible to display an image and to form a bright display portion while achieving low power consumption, even with the use of a secondary battery (a nickel-hydrogen battery or the like). The memory portion 712 is formed using a hard disk or a nonvolatile memory. For example, a NAND type nonvolatile memory with a memory capacity of 20 to 200 gigabytes (GB) is used and the digital player is operated with the use of the operation portion 713, whereby an image or sound (music) can be recorded or reproduced.

It is to be noted that power consumption of the display portion 704 and the display portion 711 can be reduced when white characters are displayed on a black background. This is effective especially in a portable audio device.

As described above, an application range of the light-emitting device of the present invention is extremely wide, and the light-emitting device can be applied to electronic appliances of all fields. The use of the light-emitting device of the present invention makes it possible to provide an electronic appliance which consumes low power and has highly-reliable display portion.

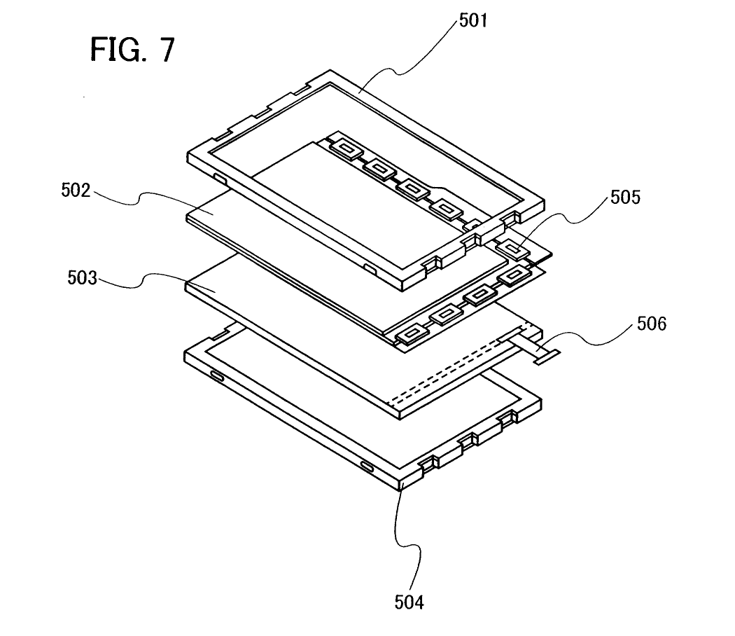

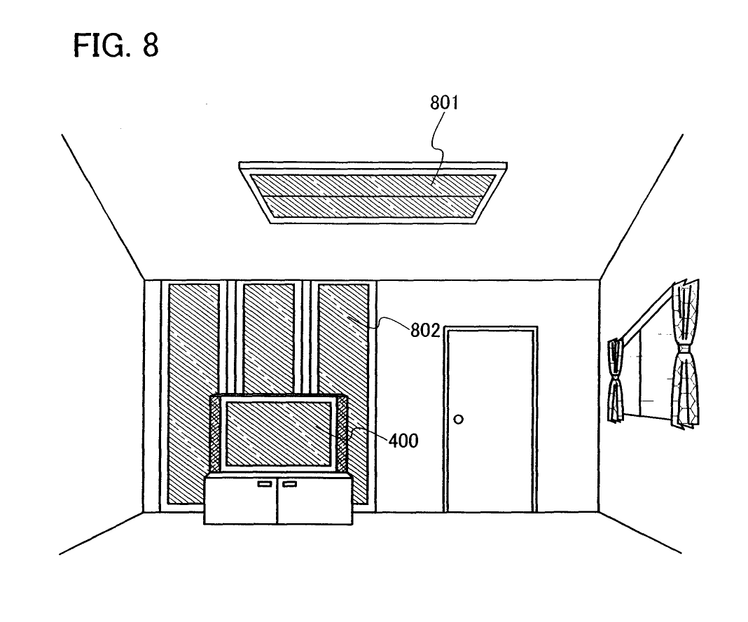

In addition, the light-emitting device of the present invention has a light-emitting element with high light emission efficiency, and the light-emitting device can be used as a lighting device. One mode of using the light-emitting element of the present invention as a lighting device will be explained with reference to FIG. 7 and FIG. 8.

FIG. 7 is an example of a liquid crystal display device in which the light-emitting device of the present invention is used as a backlight. The liquid crystal display device shown in FIG. 7 includes a housing 501, a liquid crystal layer 502, a backlight 503, and a housing 504, and the liquid crystal layer 502 is connected to a driver IC 505. The light-emitting device of the present invention is used for the backlight 503, and current is supplied thereto by a terminal 506.

The light-emitting device of the present invention is used as the backlight of the liquid crystal display device, whereby a backlight with reduced power consumption can be obtained. In addition, the light-emitting device of the present invention is excellent as a lighting device of a plane emission type and enlargement is possible. Therefore, enlargement of the liquid crystal display device is possible with enlargement of the backlight. Furthermore, the light-emitting device is thin and consumes low power, and thus, the display device can be made thin and power consumption thereof can be reduced.

FIG. 8 is an example in which a light-emitting device to which the present invention is applied is used as an indoor lighting device, that is, lighting apparatus 801 and 802. A mode in which the lighting apparatus 801 is fixed to the ceiling and the lighting apparatus 802 is embedded in the wall is shown. The light-emitting device of the present invention can be enlarged; therefore, the light-emitting device can be used as a large-sized lighting device. In addition, the light-emitting device of the present invention is thin and consumes low power; therefore, the light-emitting device can be used as a lighting device that is thin and consumes low power. In a room where the light-emitting device to which the present invention is applied is used as the indoor lighting apparatus 801, a television device 400 of the present invention as described in FIG. 4A is provided, whereby public broadcasting and movies can be enjoyed. In such a case, both devices consume low power, and thus, impressive images can be enjoyed in a bright room without a worry of electricity bill.

The light-emitting device is not limited to the lighting device shown in this embodiment mode, and the light-emitting device can be applied as lighting devices of various modes including lights of houses or public facilities. In such a case, the lighting device of the present invention has a light-emitting medium with a thin film state, and accordingly, great flexibility of design is allowed; therefore, elaborately-designed goods can be provided to the market.

### EMBODIMENT 1

5 g of zinc sulfide (ZnS), 140 mg of manganese sulfide, and 15 mg of silicon were mixed in a mortar, and a sample was put in a crucible. The crucible was set in an electric furnace, and the sample was pre-baked at 150° C. under a nitrogen atmosphere for an hour. After the pre-baking, the temperature of the electric furnace was set at 1000° C., and the sample was baked therein for 4 hours. Thereafter, the baked sample was collected, impurities were removed with acetic acid, ozone water, a potassium cyanide (KCN) solution, or the like, and the sample was washed with pure water. After that, filtration of a product was performed, and the obtained product was dried at 100° C. for 4 hours.

### COMPARATIVE EXAMPLE 1

5 g of zinc sulfide (ZnS) and 140 mg of manganese sulfide were mixed in a mortar, and a sample was put in a crucible. The crucible was set in an electric furnace, and the sample was pre-baked at 150° C. under a nitrogen atmosphere for an hour. After the pre-baking, the temperature of the electric furnace was set at 1000° C., and the sample was baked therein for 4 hours. Thereafter, the baked sample was collected, impurities were removed with acetic acid, ozone water, a KCN solution, or the like, and the sample was washed with pure water. After that, filtration of a product was performed, and the obtained product was dried at 100° C. for 4 hours.

The samples made as described above were irradiated with light having a wavelength of 356 nm to be excited, and visual comparison of the samples was carried out. As a result, it was found that the sample to which silicon was added, which was made in Embodiment 1, had higher luminescence intensity than that of the sample to which silicon was not added. Accordingly, light emission intensity could be increased when a material containing a light-emitting substance, a base material, and an additive was used for a light-emitting material.

### EMBODIMENT 2

10 g of zinc sulfide (ZnS), 0.01 g of copper sulfide, 0.467 g of magnesium chloride, and 0.207 g of sodium chloride were mixed in a mortar, and a sample was put in an alumina crucible. The crucible was set in an electric furnace, and the sample was pre-baked at 150° C. under a nitrogen atmosphere for an hour. After the pre-baking, the temperature of the electric furnace was set at 1100° C., and the sample was baked therein under a nitrogen atmosphere for 4 hours. Thereafter, the baked sample was collected and washed with pure water. Then, a product obtained by filtration was dried at 180° C. under vacuum for 2 hours. In this manner, ZnS:Cu, Cl was obtained.

Furthermore, 3 g of obtained ZnS:Cu, Cl and one element belonging to group 14 of the periodic table which is contained in ZnS at 1 atom % were mixed in a mortar, and a sample was put in an alumina crucible. It is to be noted that any of C, Ge, or Si was used as the element belonging to group 14 of the periodic table. In a case of using C, 0.0037 g of C was used; in a case of using Ge, 0.0223 g of Ge was used; and in a case of using Si, 0.0086 g of Si was used. Next, the crucible in which the sample was put was set in an electric furnace and the sample was pre-baked at 150° C. under a nitrogen atmosphere for an hour. After the pre-baking, the temperature of the electric furnace was set at 1100° C., and the sample was baked therein under a nitrogen atmosphere for 4 hours. Thereafter, the baked sample was collected and washed with pure water. Then, a product obtained by filtration was dried at 180° C. under vacuum for 2 hours, whereby a light-emitting material of the present invention was obtained.

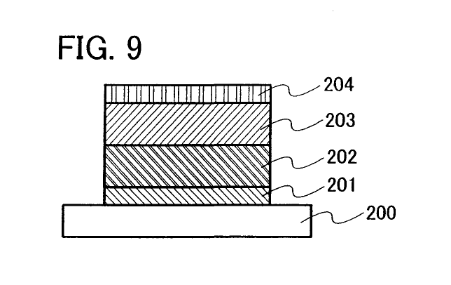

A light-emitting element was formed with the use of the light-emitting material made as described above. Hereinafter, the method will be explained with reference to FIG. 9.

First, over a glass substrate 200, an ITO film was formed to have a thickness of 110 nm by a sputtering method, so that a first electrode 201 is obtained.

A solution obtained by adding the light-emitting material made as described above to a dimethylformamide (DMF) solution in which cyanoresin (manufactured by Shin-Etsu Chemical Co., Ltd.) was dissolved and agitating to be dissolved, that is, a dissolved solution was applied onto the first electrode 201. Thereafter, the solution was dried at 120° C. for an hour to form a light-emitting layer 202. It is to be noted that weight ratio of cyanoresin to each light-emitting material was set so as to be 1:3 (=cyanoresin:light-emitting material), and the light-emitting layer 202 was formed to have a thickness of 50 μm.

Next, barium titanate was added to the DMF solution in which cyanoresin was dissolved, and the solution was agitated. The dissolved solution was applied onto the light-emitting layer 202, and the solution was dried at 120° C. for an hour to form an insulating layer 203. It is to be noted that weight ratio of cyanoresin to barium titanate was set to be 1:3 (=cyanoresin:barium titanate), and the insulating layer 203 was formed to have a thickness of 50 μm.

Ag paste was used over the insulating layer 203 to form a second electrode 204.

As described above, the light-emitting layer 202 and the insulating layer 203 are sequentially stacked between the first electrode 201 and the second electrode 204, whereby three kinds of light-emitting elements each having a different light-emitting material were formed. Further, as a light-emitting material included in each light-emitting element, each of ZnS:Cu, Cl to which C was added, ZnS:Cu, Cl to which Ge was added, and ZnS:Cu, Cl to which Si was added was used. In addition, as the comparative example, the light-emitting element using ZnS:Cu, Cl to which an element belonging to group 14 of the periodic table was not added as a light-emitting material, that is, a comparative element was formed. Further, a substance and a method that are similar to the above-described substance and method were used for forming the light-emitting element, except that the light-emitting material that was used was different.

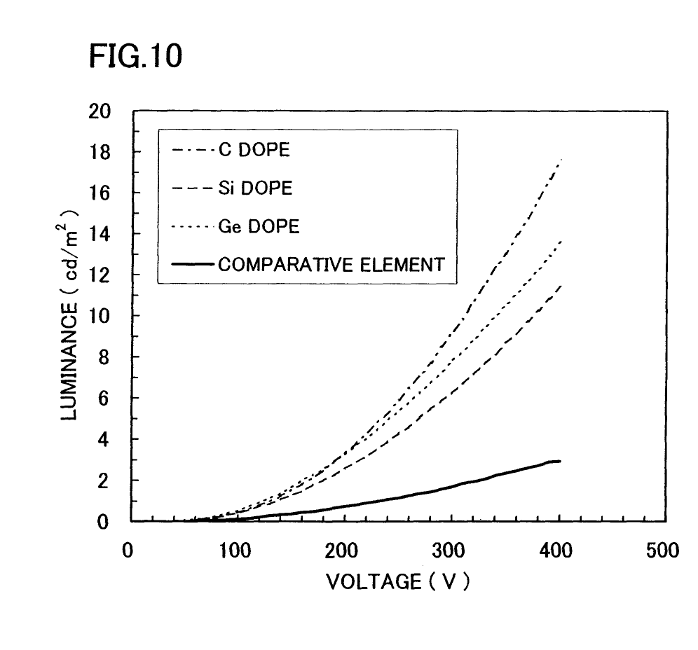

FIG. 10 shows the result of a voltage-luminance characteristic of each light-emitting element, which was obtained as described above, to which an AC voltage having a sine wave and frequency f of 1000 (Hz) was applied. It is to be noted that, in FIG. 10, a horizontal axis indicates voltage (V) and a vertical axis indicates luminance (cd/m²).

According to FIG. 10, it was found that luminance of the light-emitting element formed with the use of the light-emitting material to which the element belonging to group 14 of the periodic table was added was increased in each case where one of the elements was added, differently from the light-emitting element formed with the use of the light-emitting material in which one of the elements was not included, that is, the comparative element. It is to be noted that, when the light-emitting material to which the element belonging to group 14 of the periodic table was added was used, luminance of the light-emitting element manufactured in this embodiment was increased by approximately 5 to 9 times, in comparison with the comparative element.

Accordingly, it was found that light emission intensity can be increased by the present invention.

This application is based on Japanese Published Patent Application serial no. 2006-058758 filed in Japan Patent Office on Mar. 3, in 2006, the entire contents of which are hereby incorporated by reference.

1. A light-emitting material comprising:
a light-emitting substance;
a base material; and
an additive,
wherein the light-emitting substance is an element which becomes an emission center, and
wherein the additive is an element selected from group 14 of the periodic table.

2. A light-emitting material comprising:
a light-emitting substance;
a base material; and
an additive,
wherein the light-emitting substance is an element which becomes an emission center, and
wherein the additive is a compound containing two or more kinds of elements selected from group 14 of the periodic table.

3. A light-emitting material comprising:
a light-emitting substance;
a base material; and
an additive,
wherein the light-emitting substance is an element which becomes an emission center, and
wherein the additive is a compound containing at least two or more kinds of elements each belonging to a different group chosen from group 13, group 14, and group 15 of the periodic table.

4. A light-emitting material according to claim 3, wherein the additive contains two or more kinds of elements belonging to the same group.

5. A light-emitting material comprising:
a light-emitting substance;
a base material; and
an additive,
wherein the light-emitting substance is an element which becomes an emission center, and
wherein the additive is a compound containing at least one kind of element of each of group 13, group 14, and group 15 of the periodic table.

6. A light-emitting material according to claim 5, wherein the additive contains two or more kinds of elements belonging to the same group.

7. A light-emitting device comprising:
a first electrode;
a second electrode; and
a light-emitting layer containing a light-emitting substance, a base material, and an additive, which is interposed between the first electrode and the second electrode,
wherein the additive is an element selected from group 14 of the periodic table.

8. A light-emitting device according to claim 7, wherein an insulating layer is provided between the light-emitting layer and at least one of the first electrode and the second electrode.

9. A light-emitting device according to claim 7, wherein the light-emitting substance is an element which becomes an emission center.

10. A light-emitting device according to claim 7, wherein the base material is a compound containing at least one kind of element of each of group 2A and group 6B of the periodic table, or a compound containing at least one kind of element of each of group 2B and group 6B of the periodic table.

11. A light-emitting device according to claim 7, wherein the light-emitting substance is manganese, silver, copper, samarium, terbium, erbium thulium, europium, cerium, or praseodymium.

12. A light-emitting device comprising:
a first electrode;
a second electrode; and
a light-emitting layer containing a light-emitting substance, a base material, and an additive, which is interposed between the first electrode and the second electrode,
wherein the additive is a compound containing two or more kinds of elements selected from group 14 of the periodic table.

13. A light-emitting device according to claim 12, wherein an insulating layer is provided between the light-emitting layer and at least one of the first electrode and the second electrode.

14. A light-emitting device according to claim 12, wherein the light-emitting substance is an element which becomes an emission center.

15. A light-emitting device according to claim 12, wherein the base material is a compound containing at least one kind of element of each of group 2A and group 6B of the periodic table, or a compound containing at least one kind of element of each of group 2B and group 6B of the periodic table.

16. A light-emitting device according to claim 12, wherein the light-emitting substance is manganese, silver, copper, samarium, terbium, erbium thulium, europium, cerium, or praseodymium.

17. A light-emitting device comprising:
a first electrode;
a second electrode; and
a light-emitting layer containing a light-emitting substance, a base material, and an additive, which is interposed between the first electrode and the second electrode,
wherein the additive is a compound containing at least two or more kinds of elements each belonging to a different group chosen from group 13, group 14, and group 15 of the periodic table.

18. A light-emitting device according to claim 17, wherein an insulating layer is provided between the light-emitting layer and at least one of the first electrode and the second electrode.

19. A light-emitting device according to claim 17, wherein the light-emitting substance is an element which becomes an emission center.

20. A light-emitting device according to claim 17, wherein the base material is a compound containing at least one kind of element of each of group 2A and group 6B of the periodic table, or a compound containing at least one kind of element of each of group 2B and group 6B of the periodic table.

21. A light-emitting device according to claim 17, wherein the light-emitting substance is manganese, silver, copper, samarium, terbium, erbium thulium, europium, cerium, or praseodymium.

22. A light-emitting device comprising:
a first electrode;
a second electrode; and
a light-emitting layer containing a light-emitting substance, a base material, and an additive, which is interposed between the first electrode and the second electrode,
wherein the additive is a compound containing at least one kind of element of each of group 13 and group 14 of the periodic table.

23. A light-emitting device according to claim 22, wherein an insulating layer is provided between the light-emitting layer and at least one of the first electrode and the second electrode.

24. A light-emitting device according to claim 22, wherein the light-emitting substance is an element which becomes an emission center.

25. A light-emitting device according to claim 22, wherein the base material is a compound containing at least one kind of element of each of group 2A and group 6B of the periodic table, or a compound containing at least one kind of element of each of group 2B and group 6B of the periodic table.

26. A light-emitting device according to claim 22, wherein the light-emitting substance is manganese, silver, copper, samarium, terbium, erbium thulium, europium, cerium, or praseodymium.

27. A light-emitting device comprising:
a first electrode;
a second electrode; and
a light-emitting layer containing a light-emitting substance, a base material, and an additive, which is interposed between the first electrode and the second electrode,
wherein the additive is a compound containing at least one kind of element of each of group 13 and group 15 of the periodic table.

28. A light-emitting device according to claim 27, wherein an insulating layer is provided between the light-emitting layer and at least one of the first electrode and the second electrode.

29. A light-emitting device according to claim 27, wherein the light-emitting substance is an element which becomes an emission center.

30. A light-emitting device according to claim 27, wherein the base material is a compound containing at least one kind of element of each of group 2A and group 6B of the periodic table, or a compound containing at least one kind of element of each of group 2B and group 6B of the periodic table.

31. A light-emitting device according to claim 27, wherein the light-emitting substance is manganese, silver, copper, samarium, terbium, erbium thulium, europium, cerium, or praseodymium.

32. A light-emitting device comprising:
a first electrode;
a second electrode; and
a light-emitting layer containing a light-emitting substance, a base material, and an additive, which is interposed between the first electrode and the second electrode,
wherein the additive is a compound containing at least one kind of element of each of group 14 and group 15 of the periodic table.

33. A light-emitting device according to claim 32, wherein an insulating layer is provided between the light-emitting layer and at least one of the first electrode and the second electrode.

34. A light-emitting device according to claim 32, wherein the light-emitting substance is an element which becomes an emission center.

35. A light-emitting device according to claim 32, wherein the base material is a compound containing at least one kind of element of each of group 2A and group 6B of the periodic table, or a compound containing at least one kind of element of each of group 2B and group 6B of the periodic table.

36. A light-emitting device according to claim 32, wherein the light-emitting substance is manganese, silver, copper, samarium, terbium, erbium thulium, europium, cerium, or praseodymium.

37. A light-emitting device comprising:
a first electrode;
a second electrode; and
a light-emitting layer containing a light-emitting substance, a base material, and an additive, which is interposed between the first electrode and the second electrode,
wherein the additive is a compound containing at least one kind of element of each of group 13, group 14, and group 15 of the periodic table.

38. A light-emitting device according to claim 37, wherein an insulating layer is provided between the light-emitting layer and at least one of the first electrode and the second electrode.

39. A light-emitting device according to claim 37, wherein the light-emitting substance is an element which becomes an emission center.

40. A light-emitting device according to claim 37, wherein the base material is a compound containing at least one kind of element of each of group 2A and group 6B of the periodic table, or a compound containing at least one kind of element of each of group 2B and group 6B of the periodic table.

41. A light-emitting device according to claim 37, wherein the light-emitting substance is manganese, silver, copper, samarium, terbium, erbium thulium, europium, cerium, or praseodymium.
